(19) United States
(12) Patent Application Publication
(10) Pub. No.: US 2025/0294068 A1
(43) Pub. Date: Sep. 18, 2025

(54) Methods and Systems for Real-Time Content and Controls Streaming

(71) Applicant: Kyber SAS, Villejuif (FR)

(72) Inventor: Jean-Baptiste Kempf, Villejuif (FR)

(21) Appl. No.: 19/078,102

(22) Filed: Mar. 12, 2025

Related U.S. Application Data
(60) Provisional application No. 63/564,917, filed on Mar. 13, 2024.

(51) Int. Cl. H04L 65/61; H04L 65/65

(52) U.S. Cl. CPC H04L 65/61; H04L 65/65

(57) ABSTRACT

Methods and systems for real-time content and controls streaming are described. A computing system of a first device, responsive to performing a successful handshake between the first device and a second device, may establish a single encrypted connection with the second device. The computing system may process configuration data received from the second device. The computing system may establish, based on the configuration data, one or more reliable streams and one or more unreliable datagrams within the single encrypted connection. The computing system may communicate, via the one or more reliable streams, control data and corresponding acknowledgments between the first device and the second device. The computing system may communicate, via the one or more unreliable datagrams, media streaming data between the first device and the second device unidirectionally.

### PRIORITY

This application claims the benefit, under 35 U.S.C. § 119(e), of U.S. Provisional Patent Application No. 63/564,917, filed 13 Mar. 2024, which is incorporated herein by reference.

### TECHNICAL FIELD

This disclosure generally relates to network communication. In particular, the disclosure relates to using an improved network communication protocol and technique for achieving real-time or near real-time input and media streaming.

### BACKGROUND

Transmitting media content (e.g., video and audio streams) as well as control signals/inputs in real-time plays an important role in some of the applications and peer-to-peer communication, especially in scenarios where one of the peers is located remote or far away from another peer. As an example, real-time or near real-time audio and video streaming as well as control inputs may be useful while communicating with a remote machine, such as robots, drones, autonomous vehicles, etc. Products need real-time remote control over media, such as video. There is no performant, scalable solution to solve this. Current solutions can at best achieve ˜200 ms of responsiveness. As another example, real-time or near real-time audio and video streaming as well as control inputs may be useful for cloud gaming, where a user is sending their control inputs to a cloud or gaming server and receiving a live feed of the gameplay on their end device. As yet another example, real-time or near real-time audio and video streaming as well as control inputs may be useful for remote computing via remote desktops.

For control inputs, data reliability is important. It is generally preferred that an acknowledgment or some sort of feedback is provided to ensure that data comprising control inputs is successfully received at the other side. As such, control inputs should be transmitted reliably. For media content, such as audio and video streams, the feedback loop may be avoided and faster communication with minimal latency is usually preferred. As such, media content should be transmitted via a communication protocol that offers faster communication with low latency.

Transmission control protocol (TCP) and user datagram protocol (UDP) are two major communication protocols that have been widely used for data communication over a network. TCP provides reliable data communication by making sure that every data packet sent is received by the other side and that there is no packet loss. Specifically, for each packet exchanged between a sender device and a receiver device, the two devices share acknowledgments and/or feedback with each other to ensure that the packets have been successfully sent or received. Although TCP offers reliability, the feedback loop (e.g., multiple handshakes, sharing of acknowledgments with each other) introduces latency in the network.

UDP, on the other side, reduces this latency by eliminating the feedback loop between the devices. UDP works by sending datagrams and is generally unidirectional. Specifically, UDP may be used to send a series of datagrams to a recipient device and does not wait for an acknowledgment from the device. UDP may be used in situations where feedback and/or acknowledgment is not required, and some data loss may be tolerated by the recipient. Although UDP offers faster communication, the elimination of the feedback loop, however, makes communication via the UDP unreliable.

As discussed above, TCP and UDP both offer something of interest and each protocol has its advantages and disadvantages. For example, TCP offers reliable communication but with increased latency. TCP may be used for transmitting control signals or inputs but is not suitable for real-time media steaming. In contrast, UDP offers faster communication with reduced latency at the cost of reliability i.e., UDP is unreliable. UDP may be used for transmitting media content but is not suitable for control inputs as they require reliability.

Accordingly, there is a need in the art for an improved communication protocol and/or technique that offers both reliable and unreliable means of communication and that is capable of remote control over media content, such as, for example, video. In other words, there is a need for an improved communication protocol and/or technique that can communicate media content as well as control inputs in real time or near real time over a network. Also, there is a need for such an improved communication protocol and/or technique to be able to integrate into a web browser for web-related applications and associated communications.

### SUMMARY OF PARTICULAR EMBODIMENTS

Particular embodiments described herein relate to an improved communication protocol and/or technique for real-time streaming of control signals/inputs and media streaming content over a network. More specifically, the improved communication protocol and/or technique discussed herein achieves transmitting video and audio streams as well as control inputs in real-time between native applications or web browsers, with low latency. In one embodiment, the techniques described herein may be able to achieve significantly low or near real-time latency (e.g., 10-15 ms latency) for reliably transmitting control signals while simultaneously delivering media streams.

To achieve the goal of transmitting media content as well as control inputs with low latency between two endpoints or devices, the techniques discussed herein may establish a single encrypted connection (e.g., a QUIC connection) between a first device and a second device. Within the single encrypted connection, one or more reliable streams (e.g., QUIC streams) and one or more unreliable datagrams (e.g., QUIC datagrams) may be formed. In particular embodiments, reliable streams may be used for reliable transmission or communication of data (e.g., control data), whereas unreliable datagrams may be used for faster transmission of media streaming data. By way of an example and not limitation, since reliability is important for control inputs, the control inputs may be transmitted using reliable streams. Since dropped frames in media streams are typically non-critical for most applications, the protocol and/or technique described herein provide users with the option to transmit media streams via unreliable datagrams, which involves unidirectional communication that does not require acknowledgment of receipt and/or resending of packets. Such capabilities may be useful for applications, such as, for example, cloud gaming, remote computing via remote desktops, audio/video streaming, controlling and receiving data from remote machines (e.g., robots, drones, autonomous vehicles, etc.), remote monitoring (e.g., virtual monitor, industrial supervision, etc.), and application streaming (e.g., remote video production, trial/demo of applications, visual cloud apps, etc.).

At a high level, the improved communication protocol and/or techniques discussed herein allows to use a single encrypted connection between a first device and a second device. The single encrypted connection may be established responsive to a successful handshake between the two devices, as discussed later below. Within the single encrypted connection, multiple channels may be established and for each channel, data may be sent over the channel as reliable stream(s) or unreliable datagram(s). In particular embodiments, reliable stream(s) of the improved communication protocol discussed herein may be used to communicate control data bi-directionally between a first device and a second device. Unreliable datagram(s) may be used to transmit media streaming content (e.g., audio data, video data, subtitles, metadata, etc.) uni-directionally from the first device to the second device (or vice versa). To transmit a stream, several alternative protocols may be provided. For example, it may be possible to transmit a video stream at least one of (1) reliably over a single QUIC/WebTransport stream (the simplest), (2) using one QUIC/WebTransport stream per Group of Pictures, (3) using unreliable QUIC/WebTransport datagrams, or (4) using unreliable QUIC/WebTransport datagrams with Forward Error Correction (FEC). It should be noted that other protocols may be implemented, each one having its own advantages and disadvantages.

The first device discussed herein may be a remote device or machine that may be located far away from the second device. For example, the first device may be a server, a cloud computer, a drone, a robot, a virtual computer, a remote desktop, etc. The second device discussed herein may be a client device associated with an end user interacting with the first device. For example, the client device may be a smartphone, desktop, laptop, tablet, smartwatch, handheld device, gaming console, an autonomous vehicle, etc. In some embodiments, the client device may include a client application, such as a web browser, that is interacting with the first device.

In particular embodiments, the control data discussed herein may include data from the second device (e.g., client device) that is used to control a first device (e.g., a drone, a remote desktop, a virtual machine) that may be located remotely or far away from the second device. For example, control data may include user inputs received via one or more input components (e.g., mouse, keyboard, webcam, etc.) of the second device. Since it is important to ensure that control inputs relating to controlling a remote machine are not lost during transmission and received in the correct order, such control inputs, data, or signals are sent using the reliable stream(s) of the QUIC protocol so that sent packages are acknowledged and resent if needed.

With respect to media streaming (e.g., audio, video, subtitles, metadata, etc.), data reliability is not of the utmost importance and some data loss may be acceptable. Therefore, media streaming content may be optionally sent as datagrams using the unreliable channel(s), where acknowledgment of receipt is not required, and lost data packets are not resent. Although data reliability is not considerably important for real-time media streaming content, it is desirable to have some measures for improving reliability. The technique discussed herein adds a forward erasure correction or forward error correction (FEC) to the datagrams sent over the unreliable streams of the QUIC protocol. Using the FEC, the recipient of the datagrams may determine whether any of the packets (e.g., audio/video packets) sent via the unreliable datagram(s) are corrupted. If one or more packets seem to be corrupted, the recipient may re-construct the packet(s) using the FEC (e.g., using checksum information). If re-construction is not possible, the recipient would let go of the datagram and move on without requesting for the corrupt data to be re-transmitted.

In particular embodiments, the functionality of the improved communication protocol and techniques discussed herein may be incorporated into a web browser using a WebTransport application programming interface (API). Stated differently, WebTransport API enables web browsers to communicate via QUIC. By way of an example and not limitation, WebTransport API may be used when a user is doing cloud gaming through a web browser connected to a gaming server. In such a scenario, to be able to communicate data (e.g., real-time gameplay) from the gaming server to the web browser over unreliable channel(s) of the QUIC as datagrams, this may be implemented via the WebTransport API.

The following numbered examples represent embodiments of the present disclosure.

Example 1-a method including, by a computing system of a first device: responsive to performing a successful handshake between the first device and a second device, establishing a single encrypted connection with the second device; processing configuration data received from the second device, wherein the configuration data includes at least an indication of a number of reliable streams for control data communication and an indication of a number of unreliable datagrams for media data communication; establishing, based on the configuration data, one or more reliable streams and one or more unreliable datagrams within the single encrypted connection; communicating, via the one or more reliable streams, control data and corresponding acknowledgements between the first device and the second device; and communicating, via the one or more unreliable datagrams, media streaming data between the first device and the second device unidirectionally.

Example 2—the method of Example 1, wherein the media streaming data includes one or more media packets, and wherein the method further includes: communicating, via the one or more unreliable datagrams, one or more parity packets between the first device and the second device unidirectionally, wherein the one or more parity packets are used to reconstruct one or more lost or corrupted media packets at the second device.

Example 3—the method of Example 2, wherein in an event the second device is unable to reconstruct the one or more lost or corrupted media packets, the method further includes receiving a request from the second device to re-transmit the one or more lost or corrupted media packets; or ignoring the one or more lost or corrupted media packets.

Example 4—the method of Example 1, wherein communicating the control data and corresponding acknowledgments includes receiving, via the one or more reliable streams, the control data from the second device to control the first device; and sending, via the one or more reliable streams, an acknowledgment or receipt of the control data to the second device.

Example 5—the method of Example 1, wherein the media streaming data includes one or more media packets, and wherein communicating the media streaming data includes continuously sending, via the one or more unreliable datagrams, the one or more media packets from the first device to the second device without waiting for acknowledgement or receipt of the one or more media packets from the second device.

Example 6—the method of Example 1, wherein the single encrypted connection includes one or more channels.

Example 7—the method of Example 6, wherein the one or more reliable streams and the one or more unreliable datagrams are associated with the one or more channels.

Example 8—the method of any one of Examples 1 to 7, wherein the one or more reliable streams and the one or more unreliable datagrams are associated with a QUIC transport layer network protocol.

Example 9—the method of any one of Examples 1 to 8, wherein the first device includes one of a drone, a robot, a remote desktop, a cloud server, and a cloud computer, and the second device includes one of a smartphone, a desktop, a laptop, a tablet, a smartwatch, a handheld device, and a gaming console.

Example 10—the method of any one of Examples 1 to 9, wherein the control data includes one or more user inputs via one or more input components associated with the second device to control the first device, and wherein the media streaming data includes one or more of video, audio, subtitles, or metadata.

Example 11—In some aspects, techniques described herein relate to one or more computer-readable non-transitory storage media embodying software that is operable when executed by a computing system to perform the method of any one of Examples 1 to 10.

Example 12—In some aspects, the techniques described herein relate to a computing system including: one or more processors; and one or more computer-readable non-transitory storage media coupled to the one or more processors and including instructions operable when executed by the one or more processors to cause the computing system to perform the method of any one of Examples 1 to 10.

The embodiments disclosed herein are only examples, and the scope of this disclosure is not limited to them. Particular embodiments may include all, some, or none of the components, elements, features, functions, operations, or steps of the embodiments disclosed herein.

### BRIEF DESCRIPTION OF THE DRAWINGS

FIG. 1 illustrates an example network environment associated with a first device and a second device for real-time media content and controls streaming.

FIG. 2 illustrates an example network topology, in accordance with particular embodiments.

FIGS. 3A and 3B illustrate an example processing of media packets at a sender side and a receiver side, respectively.

FIG. 4 is an example schema illustrating config packets and pending media packets associated to different groups at a receiver side.

FIG. 5 illustrates an example data flow diagram depicting how a client establishes a connection with a server for communication via an improved communication protocol/technique discussed herein.

FIG. 6 illustrates an example block diagram of various transport/communication protocols.

FIG. 7 illustrates an example user interface depicting a plurality of configuration parameters that a user can enter to establish and/or configure a connection.

FIG. 8 is an example illustrating a sequence of packets produced by a capture tool and sent to a component associated with an improved communication protocol discussed herein.

FIG. 9 is an example illustrating example packets associated with a reliable transmission.

FIG. 10 illustrates an example Group of Pictures (GoP) stream containing three example GoPs.

FIG. 11 illustrates example QUIC streams transmitted between a client and a server.

FIG. 12 illustrates an example of what a kyproto receiver may send to a client.

FIG. 13 illustrates an example representation of media packets split into and sent as datagrams.

FIG. 14 illustrates example events at a receiver side.

FIG. 15 illustrates example datagram segments and packets at a receiver side.

FIG. 16 is an example illustrating example repair symbols and a total number of symbols that may be associated with source symbols encoded at a sender side.

FIG. 17 illustrates an example method for real-time media content and controls streaming, in accordance with particular embodiments.

FIG. 18 illustrates an example computer system.

### DESCRIPTION OF EXAMPLE EMBODIMENTS

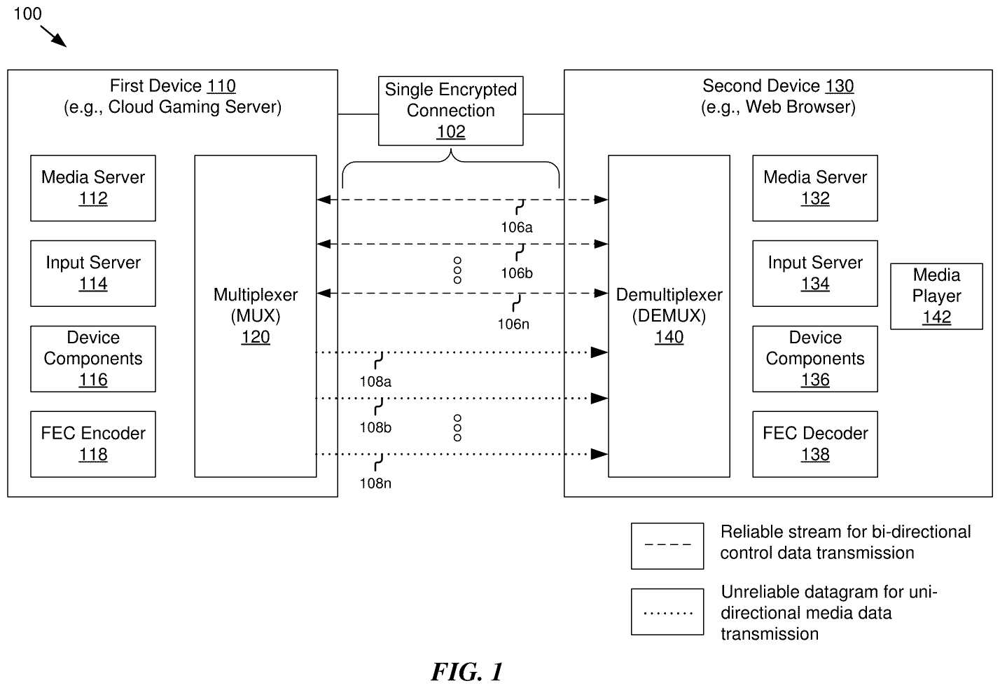

FIG. 1 illustrates an example network environment 100 associated with a first device 110 and a second device 130 for real-time media content and controls streaming. By way of an example and without limitation, the network environment 100 may be a cloud gaming environment, where the first device 110 may be a cloud or gaming server and the second device 130 may be an end user device, such as a gaming console or a handheld user gameplay device, receiving a live feed of the gameplay from the first device 110. As another example, the network environment 100 may be a remote computing, monitoring and/or streaming environment, where the first device 110 may be a remote machine or device (e.g., a drone) and the second device 110 may be an end user's device, such as user's smartphone, controlling the remote machine/device by sending control signals (e.g., directional inputs) and receiving real-time or near real-time audio and video streaming from the remote machine.

In some embodiments, the second device 130 sending the control signals to the first device 110 may be an application running on the second device 130, such as a web browser. Other examples of the second device 130 may include, for example and without limitation, a desktop, a laptop, a tablet, a smartwatch etc. Basically, the second device 130 may be a device or an application that is on a receiving end to receive a real-time or near real-time media content (e.g., video streaming, audio, subtitles, metadata) from the first device 110. The first device 110 may be a device that is on a sending end to send a real-time or near real-time media content to the second device 130 based on control signals from the second device 130. The first device 110 may be located remotely or at a distant location from the second device 130 and may include, for example and without limitation, a remote desktop, a cloud server, a cloud computer, a robot, a drone, a virtual monitor, etc.

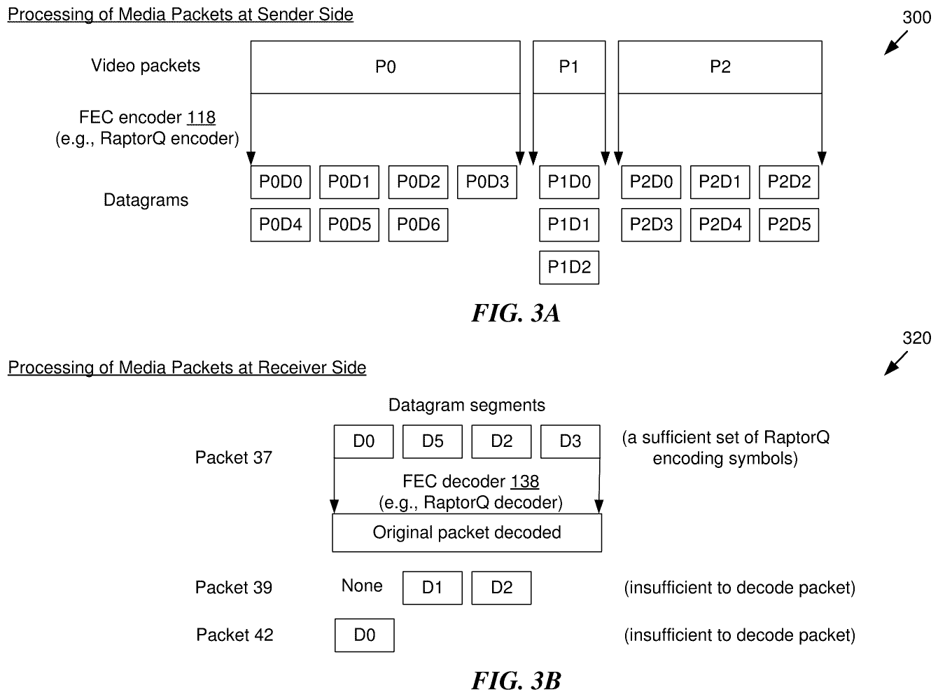

As illustrated, each of the first device 110 and the second device 130 includes a media server 112 or 132, an input server 114 or 134, device components 116 or 136, or FEC encoder/decoder 118 or 138. The media server 112 or 132 is configured to process media streaming data (e.g., audio/video packets, subtitles, metadata, etc.). For example, the media server 112 on the first device 110 may be configured to process the media streaming data that it has captured via its device components 116 (e.g., camera, microphone, sensors, etc.) and send the processed media streaming data to second device 130 for real-time or near real-time media streaming. In one embodiment, processing the media streaming data by the media server 112 may include splitting the media streaming data into one or more media packets and then encoding the media packets into datagrams for transmission, as shown, for example in FIG. 3A. The media server 132 on the second device 130 may receive the media streaming data from the first device 110, process the received media streaming data, and send the processed media streaming data to a media player 142 for streaming. In one embodiment, processing the media streaming data by the media server 132 may include re-assembling or decoding the received datagrams into their respective media packets and reconstructing the media streaming data associated with the media packets, as shown, for example in FIG. 3B.

The input server 114 or 134 is configured to process control signals or inputs. For example, the input server 134 on the second device 130 may be configured to process control inputs (e.g., mouse inputs, keyboard inputs, gamepad inputs, speech input, etc.) received from the device components 136 (e.g., mouse, keyboard, microphone, etc.) associated with the second device 130 and send the control inputs to the first device 110, where the input server 114 processes these inputs to control the first device 110 accordingly.

The FEC encoder 118 and FEC decoder 138 are used to implement a forward error correction (FEC) scheme for recovering lost or corrupted packets during transmission, as discussed in detail later below. Also, as depicted, the first device 110 includes a multiplexer (MUX) 120 and the second device 130 includes a demultiplexer (DEMUX) 140. The MUX 120 may be configured to multiplex multiple streams and/or datagrams into a single channel for transmission. The DEMUX 140 may be configured to split or convert the multiplexed single channel back to multiple streams and/or datagrams. Each of the components associated with the first device 110 and the second device 130 is further discussed below.

In particular embodiments, communication between the first device 110 and the second device 130 may begin with the first device 110 and the second device 130 performing an initial handshake procedure to establish a connection 102. The handshake procedure may include, for example, the first device 110 receiving the required/necessary security keys and/or certificates from the second device 130, and then verifying the received security keys and/or certificates. Additionally, as part of the initial handshake procedure or as a separate step after successful handshake procedure, the first device 110 may also receive a local configuration file and/or data from the second device 130. The configuration file and/or data may indicate data type or needs (e.g., media streaming needs) of the second device from the first device, an indication of a number of channels that may need to be established between the two devices for data communication, an indication of a number of reliable streams that may be needed to communicate control data between the first and second devices, and an indication of a number of unreliable datagrams that may be needed to transmit media streaming content from the first device to the second device.

Once the initial handshake procedure is successfully performed, the first device 110 may establish a single encrypted connection 102 with the second device 130 for data communication. More specifically, once the initial handshake procedure is successfully performed, a QUIC connection 102 may be established between a multiplexer (MUX) 120 located at the sender (e.g., the first device 110) and a demultiplexer (DEMUX) 140 located at the receiver (e.g., the second device 130). The connection that is established may support multiplexing any number of streams 106a . . . 106n (individually and/or collectively herein referred to as 106) and any number of datagrams 108a . . . 108n (individually and/or collectively herein referred to as 108). Although, three streams 106 and three datagrams 108 are depicted in FIG. 1, it should be noted that the present disclosure is not limited to this configuration and fewer or a larger number of streams and/or datagrams may be established within the connection 102 as needed. In particular embodiments, multiple channels may be formed within the single QUIC connection 102, and for each channel, any number of QUIC streams 106 and/or datagrams 108 may be formed.

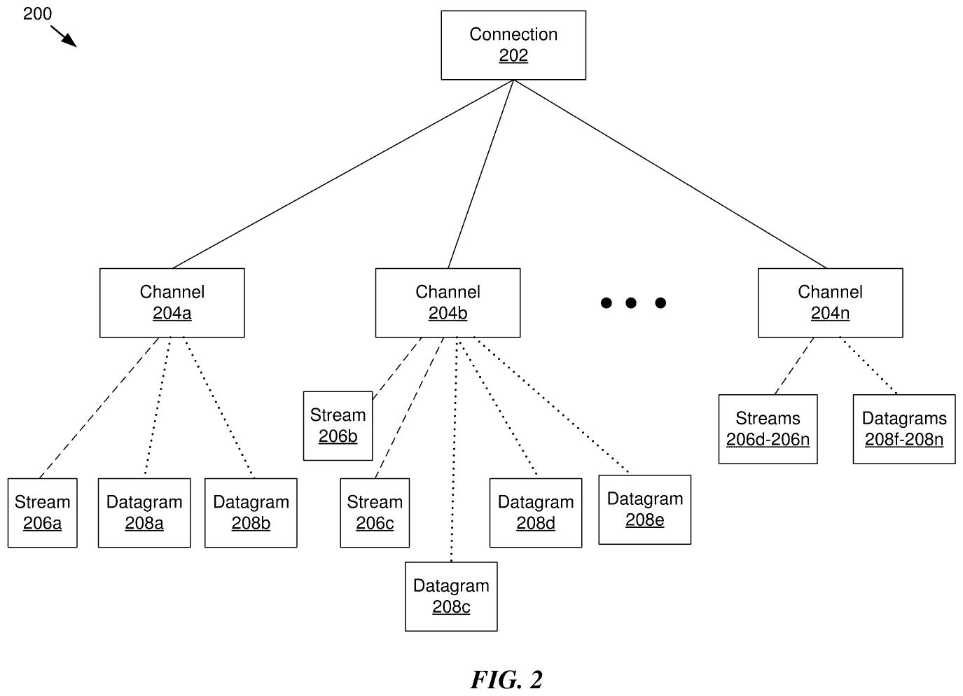

FIG. 2 illustrates an example network topology 200, in accordance with particular embodiments. As depicted, one or more channels 204a . . . 204n (individually and/or collectively herein referred to as 204) may be formed within a single connection 202, and for each channel 204, any number of streams 206a . . . 206n (individually and/or collectively herein referred to as 206) and/or any number of datagrams 208a . . . 208n (individually and/or collectively herein referred to as 208) may be formed. By way of a non-limiting example and as depicted in FIG. 2, one stream 206a and two datagrams 208a-208b may be associated with the channel 204. Two streams 206b-206c and three datagrams 208c-208e may be associated with the channel 204b. Similar, any number of streams 206d-206n and/or datagrams 208f-208n may be associated with the channel 208n.

The number of QUIC streams 206 and datagrams 208 may be independent of other channels 204. Each channel 204 that is established within the single connection 202 may include one or more reliable streams 206 and one or more unreliable datagrams 208. The communication endpoints established between the first and second devices may be based on the configuration file/data received from the second device 130 as part of the handshake procedure. For each new QUIC/WebTransport stream, the creator writes an endpoint ID. This allows the peer to associate the stream to the expected channel, so that each component have their own isolated sets of QUIC/WebTransport streams. Similarly, the payload of each QUIC/WebTransport datagram is prefixed by the endpoint ID, so that the receiver can route it to the expected channel. Thereafter, the streams and datagrams are created as needed by protocol driver implementations.

As discussed earlier, the one or more reliable streams 106 may be used to transmit data bi-directionally between the first device 110 and the second device 130. In particular embodiments, the one or more reliable streams 106 of the QUIC connection 102 may be used to communicate control data between the first device 110 and the second device 130. By way of an example and not limitation, the second device 130 may be a smartphone and the first device 110 may be a drone flying in the air. The smartphone may send control inputs, such as left, right, up, down signals to control the direction or movement of the drone. Based on each input, the drone may send feedback or some sort of acknowledgment indicating that the input has been received by the drone. Such control communication may happen over the one or more reliable streams 106 of QUIC connection. Additionally, the drone may send its media feed (e.g., audio, video) recorded by a camera of the drone back to the smartphone over the one or more unreliable datagrams 108 of the QUIC connection. For example, based on the left signal received from the smartphone as a control input over a reliable sub-stream, the drone may send the latest video recorded by its camera to the smartphone via unreliable datagrams 108. The media feed or content may be sent as a series of datagrams from the drone to the smartphone over one or more unreliable datagrams 108. Since the drone does not wait for an acknowledgment from the smartphone confirming receipt of a datagram, the drone may continue to send datagrams. In this manner, latency between the media feed recorded by the drone and the media feed received by the smartphone is reduced, and therefore content may be viewed on the smartphone in near real-time.

In particular embodiments, the data to be sent by the first device 110 may be multiplexed by the MUX 120 (e.g., a software-implemented routing mechanism residing on the controller) and sent over the designated stream or datagram. When the connection is set up, certain types of data would be designated for transmitting via a particular reliable stream 106 or unreliable datagram 108. For example, control signals may be designated for transmission via a reliable stream, and video may be designated for transmission via unreliable datagrams. For example, the series of datagrams including media content (e.g., audio, video, subtitles, metadata) may be multiplexed by the MUX 120 located at the controller and then the multiplexed datagrams may be sent over the unreliable channel designated for video transmission. The multiplexed data may be received by a DEMUX 140 located at the second device 130. The DEMUX 140 may de-multiplex the received data and route to the local video decoder and accessed via an appropriate medium located at the second device 130. For example, the media feed or streaming content (e.g., audio, video) received from the first device 110 may be demultiplexed and then played via a media player 142 installed on the second device 130. As another example, acknowledgments for control signals or inputs may be multiplexed by the MUX 120 located at the first device 110 and then the multiplexed data may be sent over the reliable stream(s) 106 designated for control transmission. The multiplexed data may be received by a DEMUX 140 located at the second device 130. The DEMUX 140 may de-multiplex the received data and route to an appropriate medium located at the second device 130.

In particular embodiments, in order to avoid data loss and increase the reliability of the media streaming data transmitted as unreliable datagrams, the system may employ an error correction scheme. FEC, for example, is a mechanism that allows the receiver or the second device 130 to recover lost or corrupted packets without requiring the sender or the first device 110 to retransmit the data. While there are variations of FEC, it generally operates by having the data sender/source (e.g., the first device 110) transmit the actual payload with redundant data, which may be referred to as parity packets. Both the actual data (e.g., the payload) and the parity packets may be transmitted using datagrams 108. When the receiver or the second device 130 receives the datagrams, it may process the actual data along with the parity packets to recover the actual data. When the data is corrupted or incomplete, the receiver or the second device 130 could leverage the redundant information encoded in the parity packets to recover the actual data. Although FEC would not eliminate all transmission errors, it mitigates the error rate. In situations where the receiver or the second device 130 cannot confidently recover lost or corrupted data, the receiver or the second device 130 could employ one or more fallback options. For example, since the video frames transmitted over unreliable datagrams 108 are not critical, the recipient or the second device 130 could simply accept that the frame is lost and move on to the next frame. Alternatively, the recipient or the second device 130 may request the sender (e.g., first device 110) to re-transmit the lost packet. This way the technique discussed herein ensures reliability of the data transmitted as unreliable datagrams while keeping the latency to minimal as much as possible.

In particular embodiments, the functionality of the improved communication protocol and techniques discussed herein may be incorporated into a web browser using a WebTransport application programming interface (API). Stated differently, WebTransport API enables a web browser running on the second device 130 to communicate with the first device 110 (or vice versa) via QUIC. By way of an example and not limitation, WebTransport API may be used when a user is doing cloud gaming through a web browser (e.g., second device 130) connected to a gaming server (e.g., first device 110). In such a scenario, to be able to communicate data (e.g., real-time gameplay) from the gaming server to the web browser over unreliable channel(s) of the QUIC as datagrams, this may be implemented via the WebTransport API.

The improved communication protocol and/or technique discussed herein is the combination of the architecture described above using QUIC/WebTransport, and a specific protocol design called Unreliable FEC, which consists in transmitting a video stream using both streams and datagrams in a specific way to achieve good performance with low latency.

Transmitting media content (e.g., video streams) using unreliable QUIC/WebTransport datagrams with FEC is unidirectional i.e., only the video producer (e.g., the first device 110) sends packets. It can be made bidirectional if feedback from the receiver (e.g., the second device 130) is provided. The producer or the first device 110 opens a single QUIC/WebTransport unidirectional stream to the receiver or the second device 130. It first sends a codec packet, indicating the video codec, over this stream. A video encoder, such as FEC encoder 118, on the first device 110 produces packets of two kinds: config packets (SPS/PPS for H.264) and media packets (containing video frames).

Config packets are required to decode further media packets, so they are transmitted reliably over the same QUIC stream. For media packets, a Forward Error Correction scheme, such as, for example, RaptorQ is used. Please note that the present disclosure is not limited to this particular scheme and another FEC scheme can be used without impacting the general design. The FEC encoder 118 splits each media packet into RaptorQ source symbols, having a size configured to fit the maximum QUIC datagram size, and generate RaptorQ encoded symbols (having the same size). That way, each symbol is (hopefully) transmitted in its own UDP datagram. FIG. 3A illustrates an example processing 300 of media packets at a sender side (e.g., the first device 110). The FEC encoder 118 splits and/or encodes each of the media packets P0, P1, and P2 into RaptorQ encoded symbols, which are represented or transmitted as datagrams. The number of additional repair symbol is a choice made by the implementation. Each datagram may be prefixed by one or more of: an endpoint ID (necessary for routing, as explained above), a packet sequence, a group sequence, FEC Object Transmission Information, a RaptorQ Payload ID.

The packet sequence may be incremented for each packet (either config or media packet). It allows to detect missing packets and reorder them. The group sequence is an additional sequence number incremented on each config packet. Its purpose is to group packets in relation to a config packet. A media packet is only meaningful after its previous config packet. Concretely, this allows to ignore packets associated to a config packet which is not received yet.

At the receiving end, the receiver (e.g., the peer consuming the video stream) or the second device 130 aggregates events from different sources. These events may include, for example, opening of new QUIC/WebTransport unidirectional stream, reception of packets over existant QUIC/WebTransport streams, or reception of QUIC/WebTransport datagrams. The receiver builds an intermediate queue of re-constructed packets (e.g., from stream packets and datagram messages). In parallel, it consumes this queue (it may also be waken up by a timeout) to send packets in order to the protocol consumer. Some packets may be missing (if not received on time, despite the Forward Error Correction). The received packets are stored in a way that facilitates processing and decision to send data to the client. Datagrams pass through an additional layer to be reordered and re-assembled. The first layer may be responsible to re-assemble packets from RaptorQ packets. FIG. 3B illustrates an example processing 320 of media packets at a receiver or the second device 130. As depicted, datagram segments may be received for each of the packets. The received packets may be out of order. For example, for packet 37, datagrams are received in following order: DO followed by datagram D5, which is followed by datagram D2, which is followed by datagram D3. These datagrams may be feed into a FEC decoder 138 (e.g., RaptorQ decoder) for each media packet, until the full original packet is recovered. The original packets may be recovered or reassembled based on whether a sufficient set of RaptorQ encoding symbols are present. As depicted, the FEC decoder 138 is able to decode or recover the original packet 37. However, the FEC decoder 138 is unable to decode packets 39 and 42 as sufficient set of datagrams are not present or are missing.

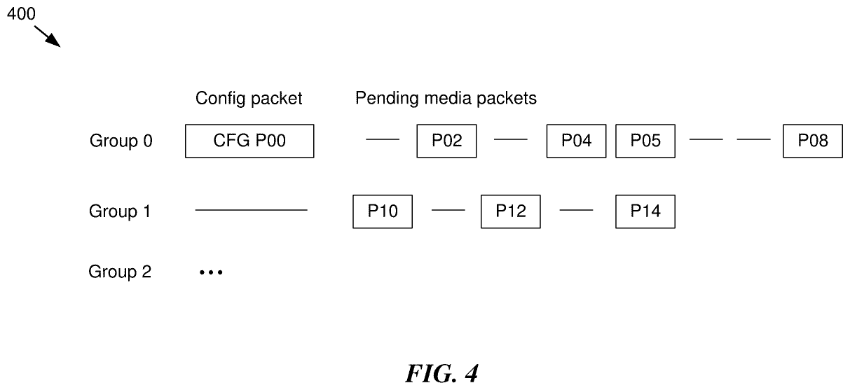

At the second device 130, the packets received from the QUIC/WebTransport stream (e.g., stream 106) or reassembled from QUIC/WebTransport datagrams (e.g., datagrams 108) are stored in a structure (e.g., PendingGroups in the schema) associated with their group sequence. This structure embeds, for example and without limitation, the config packet for each group (if the config packet is already received), the pending packets already re-assembled from datagrams, and the pending datagram segments (parts of datagram packets not re-assembled yet). FIG. 4 is an example schema 400 illustrating config packet(s) and pending media packets reassembled from datagrams associated to different groups, including groups 0, 1, and 2.

When a new event occurs (e.g., a new packet is received over a QUIC/WebTransport stream, a new datagram is received, or a deadline/timeout occurs), the receiver (or the second device 130) analyzes the current state to decide whether to send new packets to a client or end user associated with the second device 130. Following is an overview of the strategy to find the next packet to send.

If the packet with the expected next sequence number is available (whether it's a config packet or not), it is sent immediately. Otherwise, when a packet is available, but not the next one (e.g., it has a higher packet sequence number), meaning that the packets to send before it are not available yet, it may be needed to bufferize a bit to compensate for packet reordering, but it may not be ideal to wait indefinitely because the packets may be lost. Also, it makes sense to “drop” (i.e., not wait for) “lost” packets only if the next available packet may contribute to a frame. For example, if the receiver only knows the next config packet but has no media packet depending on it, it should not send it immediately, so that if it receives missing packets from a previous group beforehand, it has a chance to transmit them to the client instead of dropping them. For that purpose, the solution is to send the next available packet after some arbitrary timeout (e.g., 50 milliseconds). One less obvious problem is to decide when to start this timeout (i.e., from which starting point should the deadline be computed).

One may consider starting the timeout when this available packet is received, but this is a poor choice: the packets may be received out of order, and some more recent packets may have already been received. With this strategy, receiving an additional packet may delay the time the receiver would forward data to the client, which is undesirable. Therefore, the strategy that is designed in the protocol is to use the re-construction date of the oldest re-assembled datagram packet. In other words, for each packet, the receiver stores the reception date of the last datagram that completed it; over all re-assembled packets not sent yet (or dropped), consider the minimum (a full packet was received at this date, so the next packet was expected to be received at least as early), and adds a buffering delay. This is the new deadline to send the next packet (that may be immediately).

There is no need to timestamp config packets, which may be sent over a reliable QUIC/WebTransport stream. As mentioned earlier, a config packet will never be sent alone on a timeout basis (at least one datagram packet from the same group must be available).

### Uniqueness or Advantages of the Improved Communication Protocol/Technique

Some of the advantages and/or benefits of the improved communication protocol and/or technique discussed herein are now discussed in following subsections.

### Supporting or Mixing Reliable and Unreliable Streams on the Same Socket

The main benefits of mixing both reliable and unreliable streams on the same socket (e.g., as shown and discussed with respect to at least FIG. 1) include, for example and without limitation:
Connection is faster: there is no multiple Three-way handshake like in TCP protocol, and only one TLS session is negotiated and used. This leads to a faster initialization, and less CPU consumption just for the maintenance of the low-level communication.
Network routing and firewall management is easier and more straightforward: only one port has to be opened, only one connection needs to be managed, especially if some Network Address Translation (NAT) is involved. Moreover, in term of QoS, the packets ordering, and prioritization is completely controlled by the end-to-end agents. The intermediate network devices do not have to make some arbitrary decision on which socket packet needs to be sent first or in which order. Everything may be handled by the same network stack.
Finally, the multiple streams per socket paradigm allows a very high flexibility on the usage of the stream. For example, the improved communication protocol discussed herein provide strategies for the video bitstream transport either with one stream declared (e.g., reliable protocol variant), or with multiple streams (e.g., Group of Pictures (GoP) stream protocol variant). This cannot reasonably be achieved with a multiple socket protocol (e.g., typical GOP length are usually around one second, leading to a new connection and TLS negotiation every second).

In particular embodiments, the main benefit of having both reliable and unreliable transport for a given scenario is to fit the transport strategy with the mandatory tradeoff between reliability and latency for each different type of data that needs to be transferred between two agents (e.g., between first device 110 and second device 130).

The existing general-purpose networks and layers widely used (e.g., 5g, Wi-Fi, any internet connectivity that requires multiple routing nodes, etc.) cannot guarantee every packet can be transmitted for sure and within a guaranteed time frame. As a consequence, the protocol and the application need to determine what to do in case of network issues: whether to mitigate them either with more time (retransmission), or with more data (FEC), or to consider them obsolete. Moreover, each type of data (e.g., user inputs, audio, video, etc.) is best transmitted with a given strategy (i.e., user inputs should be retransmitted at the cost of latency, where video frames can be considered obsolete at some point during a live session). So, having the ability to use both reliable and unreliable strategies at the same time for different types of data is a real benefit for every time-based, latency-constrained data transmission.

In particular embodiments, the reliable/unreliable per-socket paradigm is heavily based on the QUIC specifications. WebTransport also offers similar concepts, as the WebTransport has been designed to offer to the Web browser API a generic abstraction layer over the QUIC protocol. The main idea is to have: a single connection ID, as described in the QUIC specification (https://datatracker.ietf.org/doc/rfc9000/); data streams, as unidirectional or bidirectional channel of ordered bytes that can be sent within the QUIC connection, and where the delivery can be guaranteed (reliable) (https://datatracker.ietf.org/doc/rfc9000/); and datagrams, as segmented portions of bytes, as defined in the QUIC extension (https://datatracker.ietf.org/doc/rfc9221/), and where the reliability is delegated to the application layer.

Cataloging/Indexing/Timestamping Across Multiple Streams that are Muxed Together

The coexistence of multiple streams inside the same socket, and the identification of the data of each stream is provided by the concept of stream ID inside the QUIC/WebTransport connection. The universal timestamping of data on top of the QUIC protocol, as well as its usage to determine the priority, the reliability strategy, the obsolescence, and the synchronization between every data regardless of their type is unique and new.

This approach can be partially found in formats like MPEG transport stream, with the concept of Program ID (PID), Program Clock Reference (PCR), and Presentation Time Stamp (PTS). With a significant difference, there is no possible way to define different transport strategies (especially reliable ones) in the same MPEG-TS transport stream. The general concept of this format is to be an agnostic data interleaving format on top of some unreliable transport. As a consequence, its muxing strategy cannot depend on the underlying transport.

The improved communication protocol discussed herein, on the other hand, suggests a specific transport protocol (QUIC/WebTransport) that provides efficient and adapted strategies for modern data streaming use cases.

### Performing FEC on Multiple Types of Streams Together

FEC efficiency is based on the information entropy of the data it tries to correct. This depends a lot on the bandwidth and the frequency of the data provided during the transport process. For example, using FEC on streams with low frequency or low bandwidth will be highly inefficient. Being able to apply forward error correction on multiple streams drastically raise the quantity of data and its frequency it applies to, smoothing the shape of the applied data traffic (e.g., by using audio and video streams), and providing enough data (and then FEC additional data) to be able to use the reconstruction of data as soon as possible.

An example of FEC strategy is described later below in one of the variants of the improved communication protocols.

Integration of Improved Communication Protocol/Technique with Existing Tools

In particular embodiments, the improved communication protocol integration in web browsers uses only standards provided by the latter, without any plugin. The protocol reference implementation may support both a native client (e.g., OS specific) and a web client. To target both platforms, the reference implementation may be compiled from Rust either to native code or to WebAssembly (WASM) code to be run from a browser and may abstract the underlying low-level protocols (QUIC or WebTransport) into a transport-layer API.

In practice, a custom Rust library (′kynet) exposes three different implementations under a common “transport” API:
a QUIC implementation (using the Rust library “Quinn”), to be used by both the server and the native clients.
a native WebTransport implementation to be used on the server side.
a web browser implementation which uses the Javascript API.

The improved communication protocols are implemented over this ‘kynet’ abstraction, so they work regardless of the underlying transport protocol. As a result, from a web browser, users just have to enter a URL (‘https://’) of a website hosting the improved communication protocol's web client. The WASM code is executed natively by the browser, and it will use the WebTransport backend to communicate with the server.

### Communication Using Improved Communication Protocol/Technique

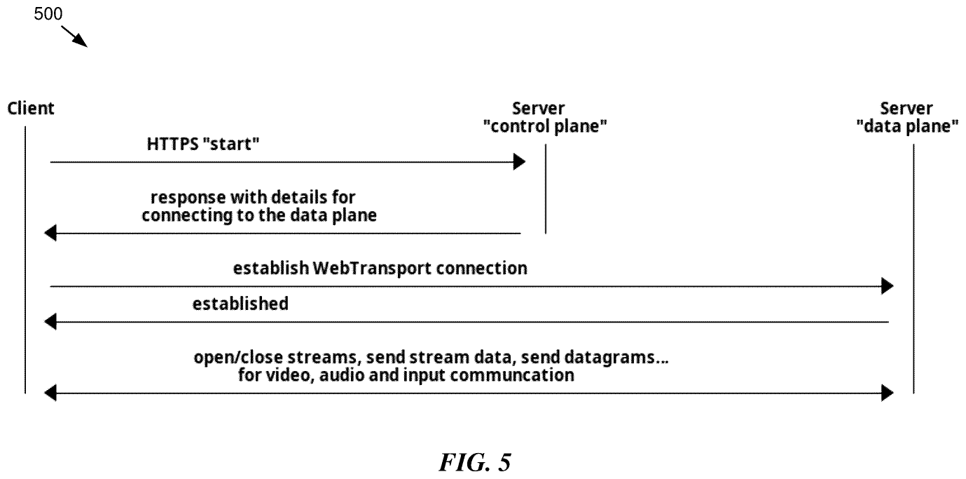

In particular embodiments, a server associated with the improved communication protocol/technique runs on two different services: the control plane (negotiating the streams, the configuration) and the data plane (transmitting the video/audio/input streams). An initial request always targets the control plane, over HTTPS. Once started, the server replies with the address/protocol to communicate with the data plane. FIG. 5 illustrates an example data flow diagram 500 depicting how a client establishes a connection with a server for communication via the improved communication protocol/technique discussed herein.

WebTransport itself is implemented as part of HTTPS since the version 3 of the protocol, itself implemented over QUIC (if available) or a fallback over TCP (if QUIC is not available), but that's a browser implementation detail.

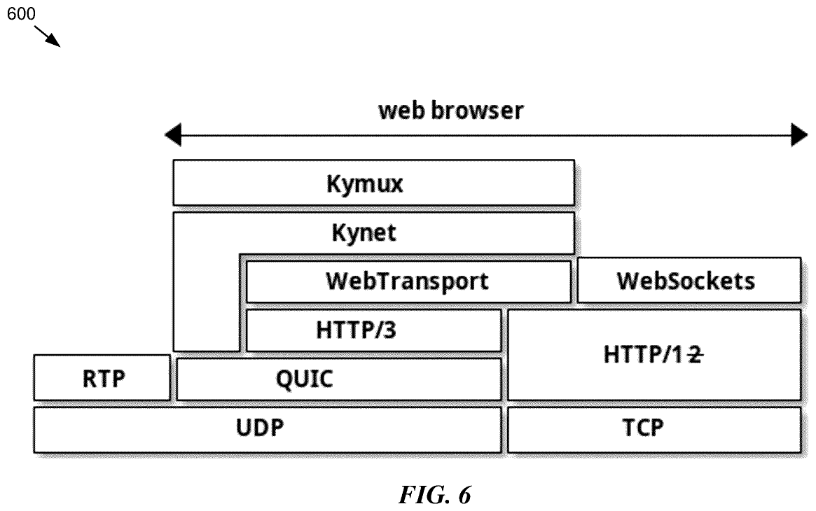

FIG. 6 illustrates an example block diagram 600 of various transport/communication protocols. Each video, audio and input streams are implemented over custom Kymux protocols. There can be several modes/implementations as follows:
Reliable: all packets are transmitted over a single QUIC/WebTransport reliable stream.
GopStream: all GoPs are transmitted over their own dedicated QUIC/WebTransport reliable stream.
Unreliable: all media packets are split and sent over QUIC/WebTransport datagrams (possibly with losses and reordering) and reconstructed on the receiver side.
Unreliable FEC: like unreliable, but with forward error correction, so that the loss of a few packets can be reconstructed.

The default recommended modes for audio, video and inputs are as follows:
Video support all these modes.
Audio supports reliable, unreliable and unreliable FEC (GoPStream is specific to video).
Inputs are always sent in reliable mode.
Other combinations are possible, based on the specificities of a particular use case.

### Example Scenario of Using Improved Communication Protocol/Technique

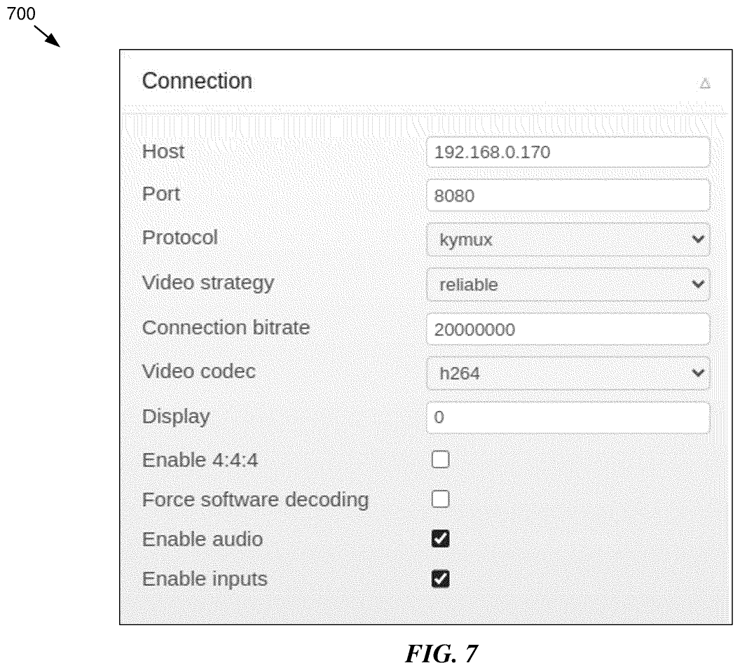

From a web browser, a user enters a URL (‘https://’) of a website hosting the protocol's WebClient. This loads the client locally in the browser. From that website, they can enter the address (e.g., IP, domain name, port, etc.) of a server (e.g., the machine they want to mirror and control), and optionally configure some parameters (e.g., video and audio strategy, bit rates, codecs, etc.). FIG. 7 illustrates an example user interface 700 depicting a plurality of configuration parameters that a user can enter to establish and/or configure a connection.

When the user click on “connect”, the web browser sends an HTTP(S) request to the server controller (e.g., the “control plane”) accessible at the provided address. The request may include many HTTP parameters to configure the session, for example ‘bitrate=20000000&codec=hevc&kymuxvideo=unreliablefec. The server replies over HTTP a JSON providing all the necessary information to connect to the data plane (typically the port, the QUIC/WebTransport server is expected to run on the same server). The client then establishes a WebTransport connection (via ‘kynet’) to the server on the given port. Once the connection is established, each captured video, audio and input streams are transmitted over this connection according to custom kymux protocols.

For streams transmitted in reliable mode, a single new QUIC stream is opened, dedicated to the video/audio/input stream. For streams transmitted in unreliable mode (with or without FEC), a mix of QUIC streams and datagrams are used to transmit the video and audio streams efficiently to the client.

### Example Use Cases

The improved communication protocol and/or technique discussed herein is extremely efficient for interactive ultra-low latency remote desktop use cases, but it is also relevant for:
Augmented remote control and rendering (e.g., remote XR, drone): as the protocol is able to provide efficient and very low latency data transport, with multiple types of timed data, any unusual type of remote control or remote rendering can benefit directly from it.
This is especially true with XR (e.g., Augmented and Virtual Reality) remote rendering, where part of the immersive scene or the entire immersive scene is rendered on a remote (usually powerful) device, and then displayed on a target VR/AR headset, where additional metadata (e.g., viewpoint coordinates, haptic feedback, etc.) needs to be transferred along with some 3D projected rendered video and audio. The improved communication protocol can provide multiple types of transport QOS (e.g., reliable, unreliable, with or without FEC) for each of the type of data, in both directions (i.e., cameras stream from an AR headset to the remote rendering device, etc.).
This can also be used as the main communication protocol for remote control of drones and any device or vehicle that needs full or occasional remote piloting. The improved communication protocol can regroup and properly transport control inputs (e.g., to the drone), audio, video, any coordinate (e.g., GPS, etc.) or session metrics through the same channel (socket), and each with an adapted protocol strategy (reliability/unreliability, FEC, etc.).

Moreover, the ultra-low latency and the ability to regroup every stream in the same protocol session allows some easy way to add some intermediate hop, such as real-time artificial intelligence (AI) processing systems. For example, any AI agent (e.g., an AI Avatar) that is able to analyze, filter, enhance any data transported by the protocol (i.e., video rendering enhancement through AI, pattern, or object recognition, user behavior analyzing or prediction, video and audio generation with generative AI models, etc.) can be added as an intermediate node on the communication workflow with minimal latency, keeping the interactive aspect of the global scenario.

Additional Description about Improved Communication Protocol/Technique

kyproto is a component responsible for transmitting video, audio, and inputs using different strategies (e.g., reliable transmission with retransmission, unreliable allowing packet loss, error correction, etc.). It is the reference implementation of the protocol variants, notably for each mode cited above. The kyproto implementation was designed to support multiple packet transmission strategies. A Rust abstraction was defined for sending and receiving packets:
′′′rust
pub(crate) trait Protocol SendDriver {
   type Packet;
   async fn send(&mut self, packet: Self::Packet)->Result<( ), ProtocolError>;
}
′′′
′′′rust
pub(crate) trait ProtocolRecvDriver {
   type Packet;
   async fn recv(&mut self)->Result<Option<Self::Packet>, ProtocolError>;
}
′′′

On one side, kyproto calls these methods to request packet transmission. On the other side, each driver provides an implementation to process sent and received packets. In particular embodiments, four drivers have been developed, as discussed later below. In the following examples, the data that may be sent from the server (e.g., first device 110) to the client (e.g., second device 130) consists of a series of packets in a well-defined format (e.g., kypacket). Each packet contains a type and headers.

There may be three types of packets:
A codec packet, initially sent, specifies the codec used (and potentially other metadata about the video stream, such as rotation).
A config packet, containing the information necessary for decoding.
Media packets, typically one packet per frame (e.g., image).

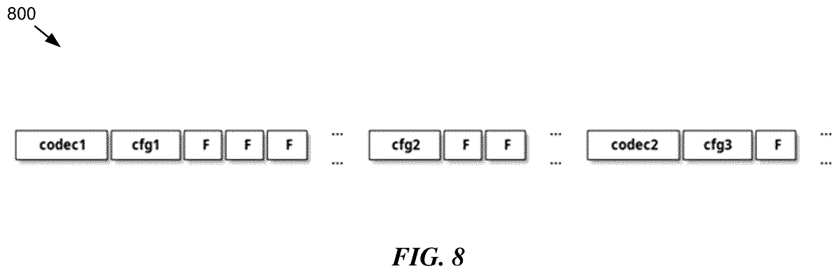

A new config packet may be sent at any time (typically at a new keyframe), as well as a new codec packet (if the codec changes or if metadata such as rotation updates). FIG. 8 is an example 800 illustrating a sequence of packets produced by a capture tool and sent to kyproto. The goal of the sending kyproto is to transmit these packets via a communication network to another kyproto instance running on the client. The goal of the receiving kyproto is to retrieve the transmitted packets and provide them to the client while maintaining the original order, albeit with potential missing packets.

### Reliable Transmission

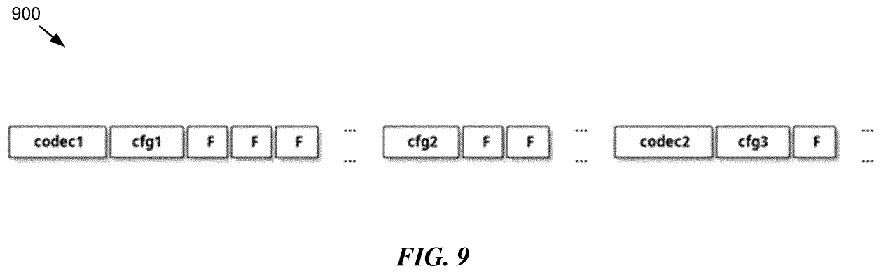

The “reliable” mode is the simplest: all data packets are sent in order over a single reliable channel (e.g., TCP). If a packet is lost on the network, it is automatically retransmitted by QUIC. Meanwhile, subsequent packets are held in a queue awaiting the missing packet. In this mode, the client (e.g., second device 130) will receive exactly the packets sent. FIG. 9 is an example 900 illustrating example packets associated with a reliable transmission. The advantage is its simplicity and the completeness of the received stream. The main drawback is that it causes latency spikes when a packet is lost on the network, as retransmission delays occur. This is not always desirable for a live video stream: if a frame from a second ago is lost, and a newer frame has already been received, it is preferable to ignore the lost frame and display the latest one as soon as possible-something not feasible in this mode.

### GoPStream

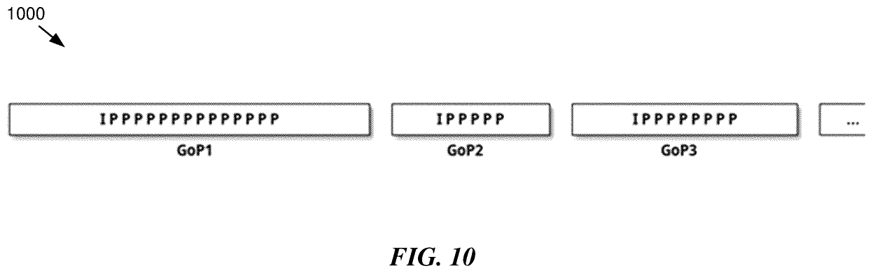

A video stream typically consists of keyframes (I-frames, I for “Intra”), which do not depend on other images to be decoded (e.g., they are self-contained), followed by a number of P-frames (P for “Predicted”), which depend on previous images (including the I-frame). A sequence containing an I-frame and all subsequent P-frames is called a Group of Pictures (GoP). FIG. 10 illustrates an example GoP stream 1000 containing three GoPs. When a frame is lost, the video stream may be corrupted until the next I-frame. The idea behind the GopStream protocol is to use a reliable QUIC stream per GoP. In practice, a new QUIC stream is started with each keyframe. The principle is to transmit a GoP reliably (with retransmissions when packets are lost, like in “reliable” mode) to avoid corrupted images, but to abandon frames from an old GoP when a new GoP has started (since receiving a new keyframe guarantees that the video stream will no longer be corrupted).

The current codec and config packets are repeated at the beginning of each QUIC stream, with an identifier so the receiver can determine if a new one needs to be sent to the client. For example, if the producer sends these packets in order:
codec1 (a codec packet)
cfg1 (a config packet)
a sequence of media packets: I P P P P P P I P P P
cfg2
a sequence of media packets: I P P P P P P
codec2
cfg3
a sequence of media packets: I P P P I P P P P

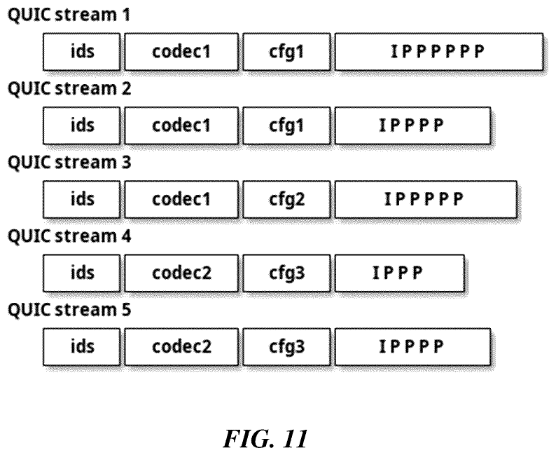

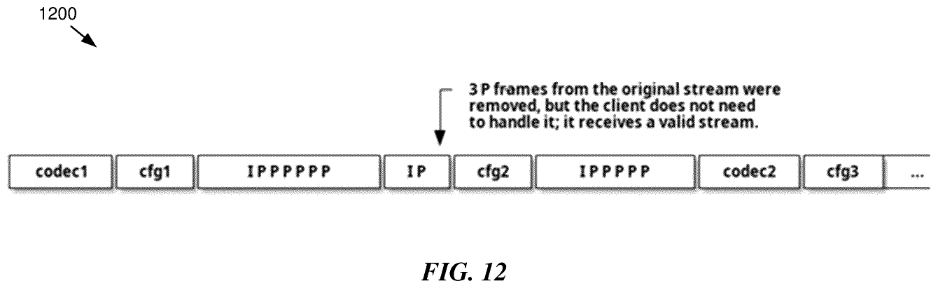

Then this protocol will transmit these data between the kyproto server and the kyproto client, as shown in FIG. 11. FIG. 11 illustrates example QUIC streams transmitted between a client and a server. Here, the ids are just two values identifying the codec and config packet numbers. They increment each time a new codec or config packet is received from the producer. The receiver uses these identifiers to ensure it sends a unique codec or config packet only once. Each time a new QUIC stream is opened by the server, the previous one is canceled, preventing retransmission of packets for old GoPs. FIG. 12 illustrates an example 1200 of what the kyproto receiver might send to the client (which expects to receive a single sequence of packets without knowing the complexity of the network transmission strategy).

### Unreliable Transmission

To avoid any retransmission when a packet is lost, the “unreliable” mode consists of manually segmenting multimedia packets and sending them in QUIC datagrams (similar to UDP). Important packets (e.g., codec and configuration packets) are still sent over a reliable channel, as they are essential for stream reconstruction. The receiver implementation is much more complex than for “reliable” mode since it must reassemble multimedia packets from out-of-order datagrams, buffer them, decide when to abandon a missing packet, associate them with the correct codec and configuration packets received on a reliable channel, etc.

When a datagram (containing part of a multimedia packet) is missing, the entire multimedia packet is considered lost. This implementation complexity is necessary to improve latency when packets are lost. However, the video stream may be partially corrupted when a packet is missing.

As with all improved communication protocols discussed herein, the unreliable transmission consists of two parts: a sender (Sender) and a receiver (Receiver).

### Sender

The sender receives three types of packets from the client (e.g., the producer):
A codec packet, which indicates the codec used. It must be sent exactly once as the first packet in the stream.
Media packets with an isconfig flag, containing configuration information for the stream (e.g., SPS/PPS for H.264 video).
Media packets without a isconfig flag, containing encoded video frames.

At startup, it opens a single unidirectional “kynet” channel (QUIC or WebTransport) to the receiver. It sends the initial codec packet and the config packets in order, prefixed by a header containing sequence numbers, as discussed elsewhere herein. On this channel, each packet has the following format: kypacketseq: 32 bits; groupseq: 32 bits; kypacket headers: 12 bytes; kypacket payload: (data size). Sequence numbers are set to 0 for codec packets (where they are unused).

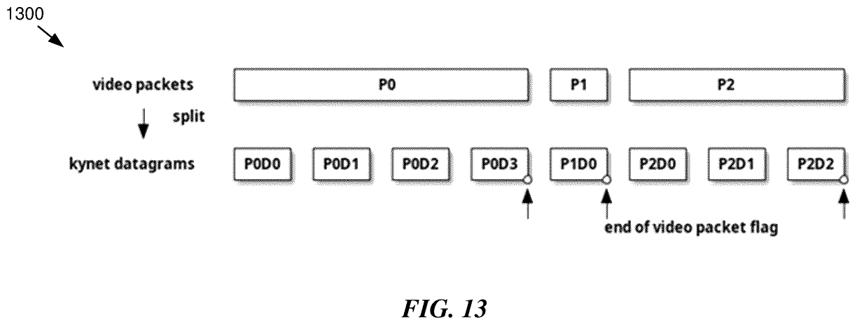

Media packets (without isconfig flag) are segmented into chunks and sent in “kynet” datagrams. FIG. 13 illustrates an example representation 1300 of media packets split into and sent as datagrams. The payload format of these datagrams is as follows:
endpointid: 16 bits
kypacketseq: 32 bits
groupseq: 32 bits
end flag: 1 bit
datagramnumber: 31 bits
kypacket segment: a portion of the kypacket “as is”

An end flag is needed to determine how many segments are expected for a given kypacket and to detect when all segments have been received and can be reassembled. For datagram transmission, the endpointid is necessary for routing, to distinguish which data stream it belongs to (e.g., a video stream datagram must not be received by the audio receiver). This is unnecessary for reliable “kynet” channels since the sender and receiver of these channels are well defined at the transport level.

### Sequence Numbers

The sequence number kypacketseq is incremented for each kypacket (whether it is a configuration packet or not). It allows detecting missing packets and reordering received packets. The additional sequence number groupseq is incremented with each configuration packet. Its purpose is to group packets related to the configuration packet they depend on. Concretely, this allows sending configuration packets (received through a reliable channel) and their dependent packets (received through an unreliable channel) to the client in the correct order.

If the application runs long enough, short sequence numbers may wrap around:
16-bit: . . . ->0xFFFE->0xFFFF->0x0000->0x0001-> . . .
32-bit: . . . ->0xFFFFFFFE->0xFFFFFFFF->0x00000000->0x00000001-> . . .

To handle this issue correctly, there are two solutions: (1) use a sufficiently large type to never wrap around (64-bit); and (2) accept that the sequence space is circular and perform only local comparisons by dividing the circular interval into two halves around the current point (0xFFFF comes before 0x4000 but after 0x8000). (1) is simple, but if multiple sequence numbers must be transmitted in a datagram, it leads to unnecessary data overhead. (2) minimizes the amount of data transmitted over the network but adds some complexity for any code using a sequence number. In particular, since the sequence number space is circular, local comparisons do not form an “order” (https://en.wikipedia.org/wiki/Orderrelation) (not even a “partial order”) because transitivity is not guaranteed (it is possible to have a<b, b<c, and c<a simultaneously). Technically, this means that sequence numbers cannot implement the Ord (https://doc.rust-lang.org/std/cmp/trait.Ord.html) trait, preventing the use of many useful functions that require Ord (e.g., Vec::binarysearch( )).

In particular embodiments, a sequencer is implemented that provides a way to retain the advantages of both approaches as follows:
The sequence number transmitted over the network can be small (e.g., 16 or 32 bits) and will wrap around after some time.
The Sequencer will “unfold” the circular sequence space to generate a 64-bit number, providing a total order for use by the receiver.

For each received sequence number, the Sequencer determines whether it is in the past or the future by comparing it to the most recent received sequence number, and it generates a 64-bit number preserving the determined order. To illustrate this mechanism, here is an example of received sequence numbers (assuming 8-bit for this example) and the 64-bit value generated by the sequencer:
0x12→0x12
0x55→0x55
0x44→0x44
0x95→0x95
0x00→0x100: the sequencer considers that the sequence has wrapped once
0xFF→0xFF
0x80→0x180
0x00→0x200: a second wrap
0x40→0x240
0x80→0x280
0x40→0x240
0xC0→0x2C0
0x40→0x340.
. . .

### Receiver

The receiver aggregates events from different sources (e.g., the opening of the unidirectional stream, packets received on this stream, segmented packets received in datagrams, etc.) into an intermediate queue of reconstructed packets. In parallel, it consumes packets from this queue to store them in a buffer ready to be consumed by the kyproto client. Since the protocol is unreliable (by design), some packets may be missing if they are not received in time. The received packets are stored in a way that facilitates processing and deciding when to send data to the client. Datagram packets go through an additional processing layer to be reordered and reassembled.

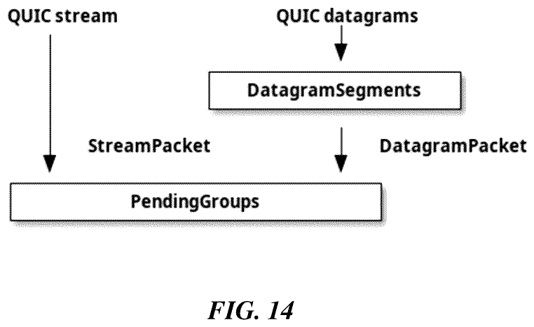

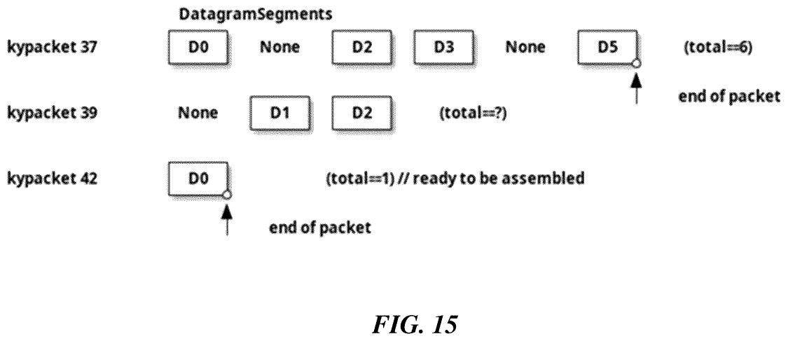

FIG. 14 illustrates example events at a receiver side. The first layer is responsible for reassembling packets from received segments. Concretely, a DatagramSegments structure keeps all received segments in order for a given sequence number until the packet can be reconstructed. FIG. 15 illustrates example datagram segments and packets at a receiver side. Once all segments are received, this layer produces a fully reassembled kypacket. Packets received from a reliable stream or reassembled from datagrams are stored in a PendingGroup associated with the group sequence number (groupseq). This structure contains: the configuration packet for this group (if already received); kypackets already reassembled from datagrams; segments of incomplete packets (not yet reconstructed). FIG. 4 illustrates example groups containing configuration packet(s) and media packets reassembled from datagrams at a receiver side.

### Packet Processing Algorithm

Upon a new event (e.g., the reception of a kypacket on a kynet stream, a new datagram, or a timeout when a deadline is reached), the receiver analyzes the current state to decide whether it should send new packets to the client (e.g., by storing them in the queue that the client can consume). Here is an overview of the strategy to decide the next packet to send (or not). First, the obvious case: if a packet with the next expected sequence number is available (whether it is a configuration packet or not), it is sent immediately. The more interesting case is when a packet is available but does not have the next expected sequence number (e.g., it has a higher kypacketseq), meaning that the packets that should be sent before it are not yet available. In this case, the receiver may need to wait for a short delay to compensate for possible reordering of packets on the network, but the receiver may not want to wait indefinitely since the expected packet might actually be lost. Moreover, it may make sense to drop a “lost” packet only if the next available packet contributes to a frame. For example, if the receiver only knows about the next configuration packet but has no media packet that depends on it, there is no point in sending it immediately. It is better to wait, so that if it receives missing packets from the current group before the deadline, it will have a chance to transmit them to the client rather than dropping them. Thus, in this case, the next relevant available packet may be sent after a certain delay (e.g., 50 ms). The remaining question is when to start counting this delay. Initially it was considered starting the countdown from the moment the packet to be sent was received. However, this turned out to be a poor choice: packets may be received out of order, and newer packets might already have been received. With this strategy, receiving an additional packet could increase the delay the receiver waits before sending data to the client, which is undesirable. As a result, another strategy is implemented using the assembly timestamp of the oldest reassembled packet. In other words, for each kypacket, the receiver stores the reception timestamp of the last datagram that completed the packet. Among all reassembled kypackets that have not yet been sent (or discarded), it considers the earliest one (since a complete kypacket was received at that moment, the next expected kypacket should have been received at least as early) and adds a delay. This becomes the new deadline for sending the next kypacket (which may be immediately). There is no need to track the timestamp of configuration packets: as explained earlier, these packets will never be sent alone based on a timeout. At least one media packet from the same group must be available.

### Unreliable FEC

The “unreliable” mode prevents blockages caused by retransmissions when packets are lost. However, since lost packets are, by definition, absent, the video stream (and eventually, the audio stream) becomes (more or less) corrupted due to missing data. To minimize the impact of packet loss, this protocol mode uses an error correction mechanism, Forward Error Correction (https://en.wikipedia.org/wiki/Errorcorrectioncode), inspired by RaptorQ (https://en.wikipedia.org/wiki/Raptorcode#RaptorQcode).

The principle is to encode the packets to be sent with some redundancy. For example, if a kypacket can be split into 10 datagrams in unreliable mode, the kypacket can be encoded into 13 datagrams so that receiving any 10 packets is enough to reconstruct the original kypacket with a very high probability. Thus, losing 3 datagrams on the network would not result in any data loss on the receiver's side, at the cost of slightly higher bandwidth usage.

The overall architecture remains the same as in unreliable mode (discussed above). The following subsections presents only the differences.

### Sender

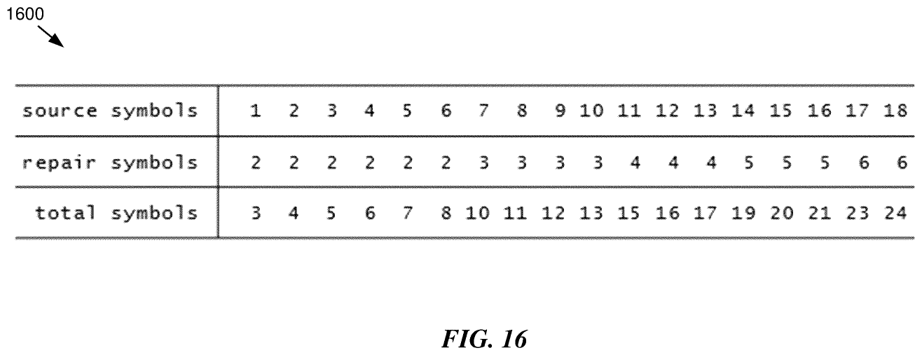

Instead of simply splitting a packet into multiple datagrams, a kypacket is sent to a RaptorQ encoder, which produces a set of symbols of the requested size, ready to be transmitted in datagrams. FIG. 3A illustrates an example encoding and splitting of media packets into datagrams at a sender side (e.g., the first device 110). The encoder may be configured so that the number of additional repair symbols (the redundancy) is a percentage (e.g., 30%) of the number of “source” symbols for each kypacket (with a minimum of at least 2 repair symbols). The idea is to have more repair symbols for larger kypackets. FIG. 16 is an example 1600 illustrating example repair symbols and a total number of symbols that may be associated with source symbols encoded at a sender side.

### Receiver

On the receiver side (e.g., second device 130), instead of manually reassembling fragments, the RaptorQ decoder (e.g., decoder 138) reassembles the symbols to reconstruct the original kypacket as soon as it has received enough data. FIG. 3B illustrates an example reconstruction of media packet(s) and/or processing of datagrams at a receiver side. The rest of the algorithm remains unchanged. In practice, this significantly improves video transmission quality, as stream corruption becomes much less frequent.

### Example Method

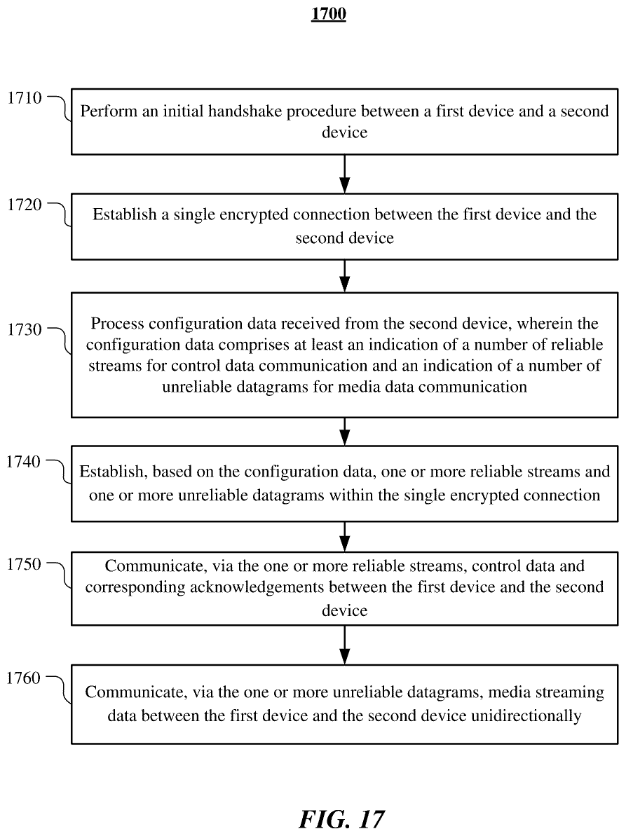

FIG. 17 illustrates an example method 1700 for real-time media content and controls streaming, in accordance with particular embodiments. The method 1700 may begin at step 1710, where a computing system (e.g., computer system 600) associated with a first device (e.g., the first device 110) may perform an initial handshake procedure between the first device and a second device (e.g., the second device 130). The handshake procedure may include, for example, the second device providing the required/necessary security keys and/or certificates to the first device, and the first device verifying the provided security keys and/or certificates. The first device may be, for example and without limitation, a drone, a robot, a remote desktop, a cloud server, or a cloud computer. The second device may include, for example and without limitation, a smartphone, a desktop, a laptop, a tablet, a smartwatch, a handheld device, or a gaming console.

At step 1720, responsive to performing a successful handshake procedure between the first device and the second device, the computing system of the first device may establish a single encrypted connection with the second device for data communication. By way of an example and not limitation, once the initial handshake procedure is successfully performed, a QUIC connection may be established between a multiplexer (MUX) located at the first device and a demultiplexer (DEMUX) located at the second device.

At step 1730, the computing system of the first device may process a local configuration file and/or data received from the second device. The configuration file and/or data may be received as part of the initial handshake procedure. Alternatively, the configuration file and/or data may be received responsive to establishing the connection (e.g., connection 102) with the second device. The configuration file and/or data may include, for example and without limitation, an indication of data type(s) or data, including control data and media streaming data, that is intended to be transmitted between the first and second devices, an indication of a number of channels that may need to be established between the two devices for data communication, an indication of a number of reliable streams that may be needed to communicate control data between the first and second devices, and an indication of a number of unreliable datagrams that may be needed to transmit media streaming data or content from the first device to the second device.

At step 1740, the computing system may establish, based on the configuration file and/or data, one or more reliable streams and one or more unreliable datagrams within the single encrypted connection. The one or more reliable streams and the one or more unreliable datagrams may be associated with a QUIC transport layer network protocol. As discussed elsewhere herein, one or more channels may be formed within the single encrypted connection, and for each channel, one or more reliable streams and/or one or more unreliable datagrams may be formed. In some embodiments, the one or more reliable streams and the one or more unreliable datagrams may be associated with the one or more channels.

At step 1750, the computing system of the first device may communicate, via the one or more reliable streams, control data and corresponding acknowledgements between the first device and the second device. The control data may include, for example, one or more user inputs received via one or more input components (e.g., mouse, keyboard, gaming remote/controller, etc.) associated with the second device to control the first device. By way of an example and without limitation, the control data may include control inputs or signals, such as left, right, up, down signals to control the direction or movement of the first device, such as a drone. In particular embodiments, communicating the control data and corresponding acknowledgements may include receiving, via the one or more of reliable streams, the control data from the second device to control the first device and sending, via the one or more reliable streams, an acknowledgment or receipt of the control data to the second device.

At step 1760, the computing system of the first device may communicate, via the one or more unreliable datagrams, media streaming data between the first device and the second device unidirectionally. The media streaming data may include, for example and without limitation, video, audio, subtitles, or metadata associated with media content that is being streamed. In particular embodiments, the media streaming data may comprise of one or more media packets, as discussed elsewhere herein, and communicating the media streaming data between the first device and the second device unidirectionally may include continuously sending, via the one or more unreliable datagrams, the one or more media packets from the first device to the second device without waiting for acknowledgement or receipt of the one or more media packets from the second device.

In some embodiments, in addition to transmitting or sending of the one or more media packets via the one or more unreliable datagrams from the first device to the second device, the computing system of the first device may also be configured to transmit or communicate, via the one or more unreliable datagrams (same or different), one or more parity packets unidirectionally from the first device to the second device. The one or more parity packets may be used to reconstruct one or more lost or corrupted media packets at the second device. For example, redundant information in the parity packets may be used for the reconstruction. In an event, the second device is unable to reconstruct the lost or corrupted media packets, the second device may send a request to the first device to re-transmit one or more of the lost or corrupted media packets. Alternatively, the second device may decide to ignore or let go of the lost or corrupted media packets.

Particular embodiments may repeat one or more steps of the method of FIG. 17, where appropriate. Although this disclosure describes and illustrates particular steps of the method of FIG. 17 as occurring in a particular order, this disclosure contemplates any suitable steps of the method of FIG. 17 occurring in any suitable order. Moreover, although this disclosure describes and illustrates an example method for real-time media content and controls streaming, including the particular steps of the method of FIG. 17, this disclosure contemplates any suitable method for real-time media content and controls streaming, including any suitable steps, which may include a subset of the steps of the method of FIG. 17, where appropriate. Furthermore, although this disclosure describes and illustrates particular components, devices, or systems carrying out particular steps of the method of FIG. 17, this disclosure contemplates any suitable combination of any suitable components, devices, or systems carrying out any suitable steps of the method of FIG. 17.

### Example Computer System

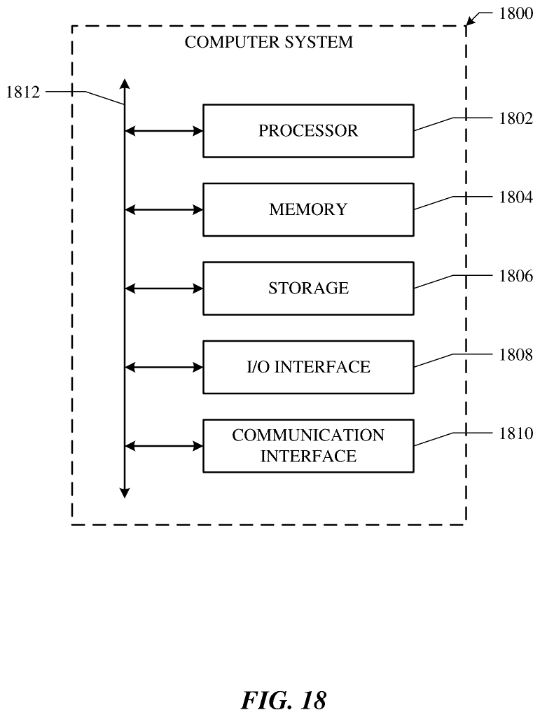

FIG. 18 illustrates an example computer system 1800. In particular embodiments, one or more computer systems 1800 perform one or more steps of one or more processes, algorithms, techniques, or methods described or illustrated herein. In particular embodiments, one or more computer systems 1800 provide the functionality described or illustrated herein. In particular embodiments, software running on one or more computer systems 1800 performs one or more steps of one or more methods described or illustrated herein or provides functionality described or illustrated herein. Particular embodiments include one or more portions of one or more computer systems 1800. Herein, reference to a computer system may encompass a computing device and vice versa, where appropriate. Moreover, reference to a computer system may encompass one or more computer systems, where appropriate.

This disclosure contemplates any suitable number of computer systems 1800. This disclosure contemplates computer system 1800 taking any suitable physical form. As example and not by way of limitation, computer system 1800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 1800 may include one or more computer systems 1800; be unitary or distributed; span multiple locations; span multiple machines; span multiple data centers; or reside in a cloud, which may include one or more cloud components in one or more networks. Where appropriate, one or more computer systems 1800 may perform without substantial spatial or temporal limitation one or more steps of one or more methods described or illustrated herein. As an example and not by way of limitation, one or more computer systems 1800 may perform in real time or in batch mode one or more steps of one or more methods described or illustrated herein. One or more computer systems 1800 may perform at different times or at different locations one or more steps of one or more methods described or illustrated herein, where appropriate.

In particular embodiments, computer system 1800 includes a processor 1802, memory 1804, storage 1806, an input/output (I/O) interface 1808, a communication interface 1810, and a bus 1812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1802 includes hardware for executing instructions, such as those making up a computer program. As an example and not by way of limitation, to execute instructions, processor 1802 may retrieve (or fetch) the instructions from an internal register, an internal cache, memory 1804, or storage 1806; decode and execute them; and then write one or more results to an internal register, an internal cache, memory 1804, or storage 1806. In particular embodiments, processor 1802 may include one or more internal caches for data, instructions, or addresses. This disclosure contemplates processor 1802 including any suitable number of any suitable internal caches, where appropriate. As an example and not by way of limitation, processor 1802 may include one or more instruction caches, one or more data caches, and one or more translation lookaside buffers (TLBs). Instructions in the instruction caches may be copies of instructions in memory 1804 or storage 1806, and the instruction caches may speed up retrieval of those instructions by processor 1802. Data in the data caches may be copies of data in memory 1804 or storage 1806 for instructions executing at processor 1802 to operate on; the results of previous instructions executed at processor 1802 for access by subsequent instructions executing at processor 1802 or for writing to memory 1804 or storage 1806; or other suitable data. The data caches may speed up read or write operations by processor 1802. The TLBs may speed up virtual-address translation for processor 1802. In particular embodiments, processor 1802 may include one or more internal registers for data, instructions, or addresses. This disclosure contemplates processor 1802 including any suitable number of any suitable internal registers, where appropriate. Where appropriate, processor 1802 may include one or more arithmetic logic units (ALUs); be a multi-core processor; or include one or more processors 1802. Although this disclosure describes and illustrates a particular processor, this disclosure contemplates any suitable processor.

In particular embodiments, memory 1804 includes main memory for storing instructions for processor 1802 to execute or data for processor 1802 to operate on. As an example and not by way of limitation, computer system 1800 may load instructions from storage 1806 or another source (such as, for example, another computer system 1800) to memory 1804. Processor 1802 may then load the instructions from memory 1804 to an internal register or internal cache. To execute the instructions, processor 1802 may retrieve the instructions from the internal register or internal cache and decode them. During or after execution of the instructions, processor 1802 may write one or more results (which may be intermediate or final results) to the internal register or internal cache. Processor 1802 may then write one or more of those results to memory 1804. In particular embodiments, processor 1802 executes only instructions in one or more internal registers or internal caches or in memory 1804 (as opposed to storage 1806 or elsewhere) and operates only on data in one or more internal registers or internal caches or in memory 1804 (as opposed to storage 1806 or elsewhere). One or more memory buses (which may each include an address bus and a data bus) may couple processor 1802 to memory 1804. Bus 1812 may include one or more memory buses, as described below. In particular embodiments, one or more memory management units (MMUs) reside between processor 1802 and memory 1804 and facilitate accesses to memory 1804 requested by processor 1802. In particular embodiments, memory 1804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1804 may include one or more memories 1804, where appropriate. Although this disclosure describes and illustrates particular memory, this disclosure contemplates any suitable memory.

In particular embodiments, storage 1806 includes mass storage for data or instructions. As an example and not by way of limitation, storage 1806 may include a hard disk drive (HDD), a floppy disk drive, flash memory, an optical disc, a magneto-optical disc, magnetic tape, or a Universal Serial Bus (USB) drive or a combination of two or more of these. Storage 1806 may include removable or non-removable (or fixed) media, where appropriate. Storage 1806 may be internal or external to computer system 1800, where appropriate. In particular embodiments, storage 1806 is non-volatile, solid-state memory. In particular embodiments, storage 1806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1806 taking any suitable physical form. Storage 1806 may include one or more storage control units facilitating communication between processor 1802 and storage 1806, where appropriate. Where appropriate, storage 1806 may include one or more storages 1806. Although this disclosure describes and illustrates particular storage, this disclosure contemplates any suitable storage.

In particular embodiments, I/O interface 1808 includes hardware, software, or both, providing one or more interfaces for communication between computer system 1800 and one or more I/O devices. Computer system 1800 may include one or more of these I/O devices, where appropriate. One or more of these I/O devices may enable communication between a person and computer system 1800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1808 for them. Where appropriate, I/O interface 1808 may include one or more device or software drivers enabling processor 1802 to drive one or more of these I/O devices. I/O interface 1808 may include one or more I/O interfaces 1808, where appropriate. Although this disclosure describes and illustrates a particular I/O interface, this disclosure contemplates any suitable I/O interface.

In particular embodiments, communication interface 1810 includes hardware, software, or both providing one or more interfaces for communication (such as, for example, packet-based communication) between computer system 1800 and one or more other computer systems 1800 or one or more networks. As an example and not by way of limitation, communication interface 1810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1810 for it. As an example and not by way of limitation, computer system 1800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1800 may include any suitable communication interface 1810 for any of these networks, where appropriate. Communication interface 1810 may include one or more communication interfaces 1810, where appropriate. Although this disclosure describes and illustrates a particular communication interface, this disclosure contemplates any suitable communication interface.

In particular embodiments, bus 1812 includes hardware, software, or both coupling components of computer system 1800 to each other. As an example and not by way of limitation, bus 1812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1812 may include one or more buses 1812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing system of a first device:
responsive to performing a successful handshake between the first device and a second device, establishing a single encrypted connection with the second device;
processing configuration data received from the second device, wherein the configuration data comprises at least an indication of a number of reliable streams for control data communication and an indication of a number of unreliable datagrams for media data communication;
establishing, based on the configuration data, one or more reliable streams and one or more unreliable datagrams within the single encrypted connection;
communicating, via the one or more reliable streams, control data and corresponding acknowledgments between the first device and the second device; and
communicating, via the one or more unreliable datagrams, media streaming data between the first device and the second device unidirectionally.

2. The method of claim 1, wherein the media streaming data comprises one or more media packets, and wherein the method further comprises:
communicating, via the one or more unreliable datagrams, one or more parity packets between the first device and the second device unidirectionally,
wherein the one or more parity packets are used to reconstruct one or more lost or corrupted media packets at the second device.

3. The method of claim 2, wherein in an event the second device is unable to reconstruct the one or more lost or corrupted media packets, the method further comprises:
receiving a request from the second device to re-transmit the one or more lost or corrupted media packets; or
ignoring the one or more lost or corrupted media packets.

4. The method of claim 1, wherein communicating the control data and corresponding acknowledgments comprises:
receiving, via the one or more reliable streams, the control data from the second device to control the first device; and
sending, via the one or more reliable streams, an acknowledgment or receipt of the control data to the second device.

5. The method of claim 1, wherein the media streaming data comprises one or more media packets, and wherein communicating the media streaming data comprises:
continuously sending, via the one or more unreliable datagrams, the one or more media packets from the first device to the second device without waiting for acknowledgement or receipt of the one or more media packets from the second device.

6. The method of claim 1, wherein the single encrypted connection comprises one or more channels.

7. The method of claim 6, wherein the one or more reliable streams and the one or more unreliable datagrams are associated with the one or more channels.

8. The method of claim 1, wherein the one or more reliable streams and the one or more unreliable datagrams are associated with a QUIC transport layer network protocol.

9. The method of claim 1, wherein:
the first device comprises one of a drone, a robot, a remote desktop, a cloud server, and a cloud computer; and
the second device comprises one of a smartphone, a desktop, a laptop, a tablet, a smartwatch, a handheld device, and a gaming console.

10. The method of claim 1, wherein:
the control data comprises one or more user inputs via one or more input components associated with the second device to control the first device; and
the media streaming data comprises one or more of video, audio, subtitles, or metadata.

11. One or more computer-readable non-transitory storage media embodying software that is operable when executed by a computing system of a first device to:
responsive to performing a successful handshake between the first device and a second device, establish a single encrypted connection with the second device;
process configuration data received from the second device, wherein the configuration data comprises at least an indication of a number of reliable streams for control data communication and an indication of a number of unreliable datagrams for media data communication;
establish, based on the configuration data, one or more reliable streams and one or more unreliable datagrams within the single encrypted connection;
communicate, via the one or more reliable streams, control data and corresponding acknowledgements between the first device and the second device; and
communicate, via the one or more unreliable datagrams, media streaming data between the first device and the second device unidirectionally.

12. The one or more computer-readable non-transitory storage media of claim 11, wherein the media streaming data comprises one or more media packets, and wherein the software is further operable when executed by the computing system of the first device to:
communicate, via the one or more unreliable datagrams, one or more parity packets between the first device and the second device unidirectionally,
wherein the one or more parity packets are used to reconstruct one or more lost or corrupted media packets at the second device.

13. The one or more computer-readable non-transitory storage media of claim 11, wherein to communicate the control data and corresponding acknowledgments, the software is further operable when executed by the computing system of the first device to:
receive, via the one or more reliable streams, the control data from the second device to control the first device; and
send, via the one or more reliable streams, an acknowledgment or receipt of the control data to the second device.

14. The one or more computer-readable non-transitory storage media of claim 11, wherein the media streaming data comprises one or more media packets, and wherein to communicate the media streaming data, the software is further operable when executed by the computing system of the first device to:
continuously send, via the one or more unreliable datagrams, the one or more media packets from the first device to the second device without waiting for acknowledgement or receipt of the one or more media packets from the second device.

15. The one or more computer-readable non-transitory storage media of claim 11, wherein the single encrypted connection comprises one or more channels, and wherein the one or more reliable streams and the one or more unreliable datagrams are associated with the one or more channels.

16. A computing system comprising:
one or more processors; and
one or more computer-readable non-transitory storage media coupled to the one or more processors and comprising instructions operable when executed by the one or more processors to cause the computing system to:
responsive to performing a successful handshake between a first device and a second device, establish a single encrypted connection with the second device;
process configuration data received from the second device, wherein the configuration data comprises at least an indication of a number of reliable streams for control data communication and an indication of a number of unreliable datagrams for media data communication;
establish, based on the configuration data, one or more reliable streams and one or more unreliable datagrams within the single encrypted connection;
communicate, via the one or more reliable streams, control data and corresponding acknowledgments between the first device and the second device; and
communicate, via the one or more unreliable datagrams, media streaming data between the first device and the second device unidirectionally.

17. The computing system of claim 16, wherein the media streaming data comprises one or more media packets, and wherein the instructions are further operable when executed by the one or more processors to cause the computing system to:
communicate, via the one or more unreliable datagrams, one or more parity packets between the first device and the second device unidirectionally,
wherein the one or more parity packets are used to reconstruct one or more lost or corrupted media packets at the second device.

18. The computing system of claim 16, wherein to communicate the control data and corresponding acknowledgments, the instructions are further operable when executed by the one or more processors to cause the computing system to:
receive, via the one or more reliable streams, the control data from the second device to control the first device; and
send, via the one or more reliable streams, an acknowledgment or receipt of the control data to the second device.

19. The computing system of claim 16, wherein the media streaming data comprises one or more media packets, and wherein to communicate the media streaming data, the instructions are further operable when executed by the one or more processors to cause the computing system to:
continuously send, via the one or more unreliable datagrams, the one or more media packets from the first device to the second device without waiting for acknowledgement or receipt of the one or more media packets from the second device.

20. The computing system of claim 16, wherein the single encrypted connection comprises one or more channels, and wherein the one or more reliable streams and the one or more unreliable datagrams are associated with the one or more channels.
